(19) United States
(12) Patent Application Publication
(10) Pub. No.: US 2023/0199460 A1
(43) Pub. Date: Jun. 22, 2023

(54) CELLULAR BASED PUBLIC WARNING SYSTEM AND METHOD OF OPERATION THEREFOR

(71) Applicant: CELLTICK TECHNOLOGIES LTD, Herzliya (IL)

(72) Inventor: Avi PRIMO, Irus (IL)

(21) Appl. No.: 18/001,833

(22) PCT Filed: Jun. 16, 2021
(86) PCT No.: PCT/IL2021/050731

§ 371 Date: Dec. 14, 2022

(30) Foreign Application Priority Data
Jun. 17, 2020 (IL) 275454

(51) Int. Cl. H04W 4/90; H04W 4/021

(52) U.S. Cl. CPC H04W 4/90; H04W 4/021

(57) ABSTRACT

A cellular based public warning system for use with Cell Broadcast Center(s) (CBC) for broadcasting cell broadcast messages to user equipment in a multitude of cells and at least two cellular networks providing at least partially overlapping cellular service to user equipment. The public warning system includes a computer implemented public warning system controller for storing locations of cells providing cellular service to user equipment, routinely initiating a CBC status check to prompt a CBC to check operability of each cell of its associated multitude of cells, compiling information regarding operable cells and inoperable cells of at least two cellular networks and employing decision logic for estimating a disaster area location based on the compiled information.

### FIELD OF THE INVENTION

The invention relates to cellular based Public Warning Systems and method of operation therefor.

### BACKGROUND OF THE INVENTION

Disaster area locations can be the result of natural processes, for example, earthquakes, floods, fires, and the like, and/or manmade processes, for example, military airstrikes, nuclear explosions, and the like. Disaster area locations are typically tracts of land that range from a few square kilometers to thousands of square kilometers. Some disasters affect a single continuous tract of land, for example, along a coast line. Other disasters, for example, forest fires, can affect several spaced apart tracts of land.

Nations have been recently successfully deploying cellular based Public Warning Systems (PWSs) for broadcasting warnings and notifications (hereinafter referred to as Cell Broadcast (CB) messages) to user equipment in disaster area locations. One of the first tasks of PWS command center staff is to determine a disaster area location as accurately and as quickly as possible for transmitting CB messages to all user equipment in the disaster area location and not transmitting CB messages to user equipment not in the disaster area location. All user equipment intended to receive the CB messages in the disaster area location should receive same irrespective of their subscription to a particular cellular operator. Determination of a disaster area location is based on incoming information from remote sensing equipment and/or emergency calls from relief personnel, security forces, affected citizens, and the like. Remote sensing equipment includes, for example, earthquake detectors, flood detectors, fire detectors, and the like.

Cellular based PWSs require at least one network entity Cell Broadcast Controller (CBC) for broadcasting CB messages to cells. Some cellular based PWSs employ a single CBC which is connected to all generation cellular networks of all cellular operators providing cellular service. Other cellular based PWSs employ CBCs which are part a cellular operator's cellular network. A cellular operator may deploy a single CBC which seamlessly transmits CB messages on its one or more cellular networks simultaneously. Alternatively, a cellular operator may deploy a dedicated CBC for each of its one or more cellular networks. Regardless of the number of deployed CBCs, cellular based PWSs require all user equipment to receive cell broadcast messages irrespective to which cellular operator a user equipment is a subscriber to.

Cellular based PWSs include a computer implemented PWS controller in real time bidirectional communication with the one or more CBCs. The computer implemented PWS controllers include a cellular service map over a geographical area. Such cellular service maps include all generation cellular networks of all cellular operators. Such computer implemented PWS controllers have one or more computer screens for displaying a geographical map of a geographical area and a cellular service map superimposed on the geographical map. Some sub-areas of a geographical area, for example, desert regions, mountainous regions, sparsely populated regions, and the like, may not have cellular service and therefore CB messages cannot be broadcast to user equipment in such sub-areas. PWS command center staff superimpose a disaster area location on a geographical map for assisting to determine which cells are required to broadcast CB messages.

Telecommunication standard bodies have published technical standards regarding cellular based Public Warning Systems and Cell Broadcast Controllers. Such telecommunication standard bodies include inter alia the 3^{rd} Generation Partnership Project (3GPP™), Telecommunication Industry Association (TIA) and Alliance for Telecommunication Industry Solution (ATIS). Reference is made to the following three technical standards:
1) 3GPP TS 22.268 V16.3.0 (2019 June) entitled Technical Specification Group Services and System Aspects: Public Warning System (PWS) requirements (Release 16)
2) 3GPP TS 23.041 V16.2.0 (2019 December) entitled Technical Specification Group Core Network and Terminals: Technical realization of Cell Broadcast Service (Release 16)
3) J-STD-101 Commercial Mobile Alert System Federal Alert Gateway to Commercial Mobile Service Provider Gateway Interface Specification
   The technical standards include inter alia maintenance protocols for ensuring PWS readiness to broadcast CB messages in disaster area locations at the time of need. Such maintenance protocols include a computer implemented PWS controller routinely initiating a CBC status check to prompt each CBC to check operability of each cell of its associated multitude of cells in terms of the cells being capable of transmitting CB messages. In the event of inoperability of one or more of its associated cells, each CBC updates same such that a computer implemented PWS controller has updated information regarding operable cells and inoperable cells of each cellular operator. The technical standard 3GPP 23.041 (V16.3.0 (2020 March)) sections regarding such maintenance protocol are:
Sections 9.2.10 & 9.2.12 for 2G/3G
Sections 9.2.22 & 9.2.23 for 4G
Sections 9.2.32 & 9.2.33 for 5G

### SUMMARY OF THE INVENTION

The present invention is based on a realization that disaster area locations can be estimated by destructive impacts of disaster occurrences on cellular networks rendering at least some of their cells inoperable in terms of being able to transmit CB messages. Such destructive impacts can occur at any node between a CBC and a cell. Such nodes include inter alia a base station, an antenna site, and the like. The present invention envisages a cellular based computer implemented PWS controller having decision logic programmed to estimate disaster area locations based on operable cells and inoperable cells of at least two cellular networks providing at least partially overlapping cellular service. Disaster area locations can be estimated as circles, ovals, ellipses and polygons. Operable cells are presumed to be indicative of an absence of a disaster area location. But inoperable cells may be inoperable due to routine electrical and/or mechanical failures and therefore are not necessarily indicative of a disaster. Routine electrical failures include, for example, burnt fuses, and the like. Routine mechanical failures include, for example, disconnected electrical components, and the like.

In other words, the present invention employs both operable cells and inoperable cells as remote sensing equipment for providing incoming information to a computer implemented PWS controller for estimating disaster area locations ranging from a few square kilometers to thousands of square kilometers. The decision logic of a particular computer implemented PWS controller is highly dependent on local factors including inter alia local topology, local weather conditions, the one or more cellular networks providing local cellular service, and the like. Generally speaking, the more cellular networks providing at least partially overlapping cellular service over the same geographical area and the more cells providing overlapping cellular service, so a computer implemented PWS controller can better estimate disaster area locations. Accordingly, the computer implemented PWS controller of the present invention can supports PWS command center staff in their role for handling disaster occurrences.

### BRIEF DESCRIPTION OF THE DRAWINGS

In order to understand the present invention and to see how it can be carried out in practice, a preferred embodiment will now be described, by way of a non-limiting example only, with reference to the accompanying drawings, in which similar parts are likewise numbered, and in which

FIG. 1A to FIG. 1C are schematic drawings of cellular service coverages of three cellular operators providing cellular service over the same geographical area;

FIG. 1D is a schematic drawing of a superimposition of the three cellular service coverages;

FIG. 2 is a schematic drawing of a computer implemented Public Warning System controller in bidirectional communication with the Cell Broadcast Controllers of the three cellular operators for broadcasting Cell Broadcast (CB) messages to user equipment;

FIG. 3 is a flow diagram of the operation of the computer implemented Public Warning System controller; and

FIG. 4 is a schematic layout of antenna sites for providing cellular service and a table including information regarding same.

### DETAILED DESCRIPTION OF THE DRAWINGS

Cellular operators typically own one or more of different generation cellular networks, namely, a 2G cellular network, a 3G cellular network, a 4G cellular network and a 5G cellular network. A cellular operator's two or more cellular networks typically have at least partially overlapping network coverage areas. Each generation cellular network includes network side entities in bidirectional communication with antenna sites each having an antenna array each having at least one antenna providing cellular service. Different generation cellular networks have different network side entities as follows: 2G cellular network include Base Station Controllers (BSCs). 3G cellular networks include Radio Network Controllers (RNCs). In 4G cellular networks and 5G cellular networks, cells are connected to eNodeB and gNodeB (NR-NB) respectively where connectivity towards cells is through Mobility Management Entity (MME) for 4G and Access and Mobility Management Function (AMF) for 5G. Cellular operators may install different generation antennas at the same antenna site for cost savings, reducing maintenance needs, and the like. For example, a cellular operator may install an antenna array including one or more 2G antennas, one or more 3G antennas, one or more 4G antennas and one or more 5G antennas.

Nations typically have two or more competing cellular operators. Cellular operators typically have at least some of the same generation cellular networks as their competitors. Different cellular operators typically have different antenna sites for their antenna arrays. However, cellular operators can share antenna sites for cost savings, reducing maintenance needs, and the like. For the purpose of the present description, an antenna site's antenna array can include all generation antennas of all cellular operators.

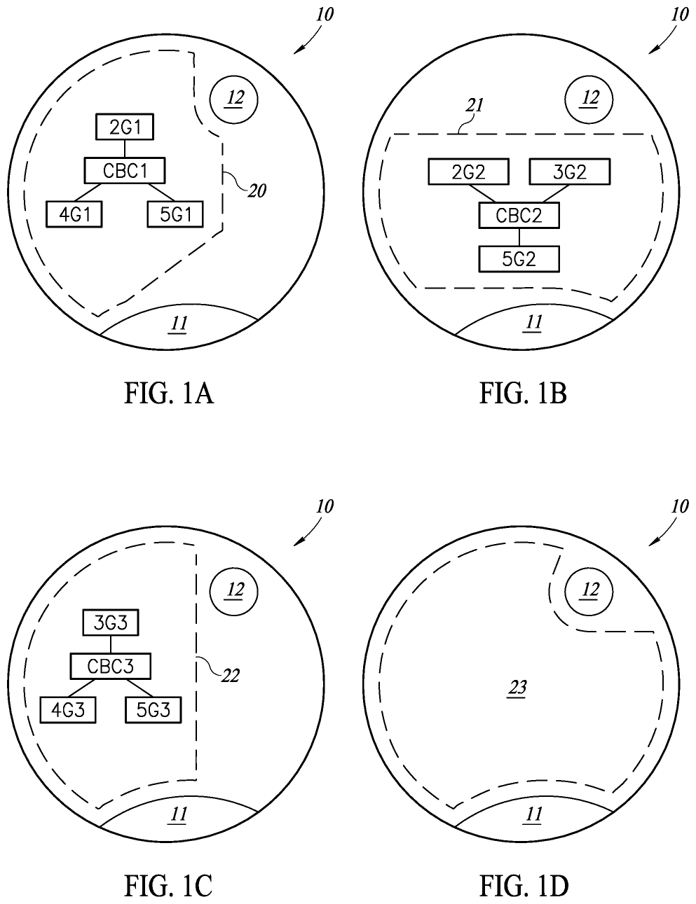

FIG. 1A to FIG. 1C schematically show a geographical area 10 and three cellular operators C01, CO2 and CO3, respectively, providing cellular service coverages 20, 21, and 22. Geographical areas may include one or more parts without cellular service. In the present case, the geographical area 10 has two sub-areas 11 and 12 without cellular service. Such sub-areas are typically natural formations, for example, mountainous regions, lakes, desert areas, and the like. Remote or sparsely populated sub-areas of the geographical area 10 may receive cellular service from a single cellular operator only. Densely populated sub-areas of the geographical area 10 typically receive cellular service from all three cellular operators CO1, C02 and CO3.

FIG. 1A to FIG. 1C show each cellular operator CO1, C02 and CO3 has a single Cell Broadcast Controller (CBC) in bidirectional communication with one or more of a 2G cellular network, a 3G cellular network, a 4G cellular network, and a 5G cellular network. The cellular operator CO1 has a CBC1 in bidirectional communication with a 2G cellular network 2G1, a 4G cellular network 4G1, and a 5G cellular network 5G1. The cellular operator CO2 has a CBC2 in bidirectional communication with a 2G cellular network 2G2, a 4G cellular network 4G2, and a 5G cellular network 5G2. The cellular operator CO3 has a CBC3 in bidirectional communication with a 3G cellular network 3G3, a 4G cellular network 4G3, and a 5G cellular network 5G3. Different generation cellular networks provide at least partially overlapping cellular service. In an alternative deployment, each cellular operator could have a dedicated CBC for each generation cellular network. In another alternative deployment, a cellular operator may not have even a single CBC but rather approve a 3^{rd} party's external CBC be connected to their cells. FIG. 1D shows a superimposition 23 of the three cellular service coverages 20, 21 and 22. The cellular operators C01, CO2 and CO3 in combination provide cellular service coverage over the entire geographical area 10 except for the sub-areas 11 and 12.

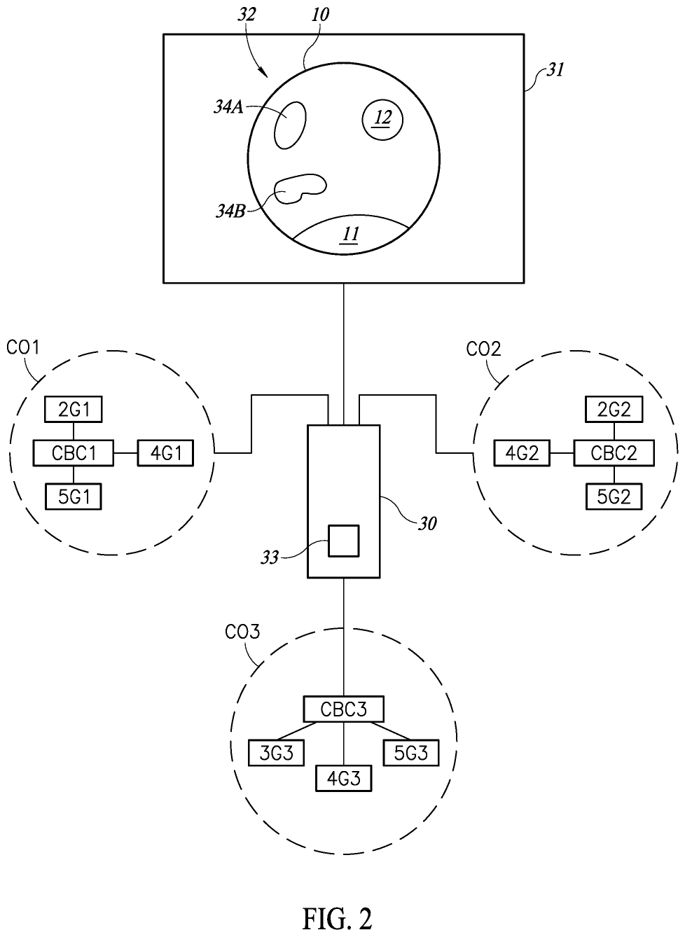

FIG. 2 shows a computer implemented Public Warning System Controller (PWSC) 30 in bidirectional communication with the CBC1, CBC2 and CBC3. In an alternative deployment, the PWSC 30 could be in bidirectional communication with a single CBC which is in turn in bidirectional communication with the cellular operator CO1's cellular networks 2G1, 4G1 and 5G1, the cellular operator CO2's cellular networks 2G2, 4G2 and 5G2, and the cellular operator CO3's cellular networks 3G3, 4G3 and 5G3.

The PWSC 30 includes a computer display 31 for displaying a geographical map 32 of the geographical area 10. The PWSC 30 displays cellular service maps of the cellular operator CO1's cellular network coverage, cellular operator CO2's cellular network coverage and cellular operator CO3's cellular network coverage superimposed on the geographical map 32. The cellular service maps include the GPS locations of all antenna sites of all cellular networks of all cellular operators providing cellular service over the geographical area 10.

The PWSC 30 is programmed with decision logic 33 for estimating disaster area locations based on operable cells and inoperable cells over the geographical area 10. Some decision logic applies to single antenna sites. Other decision logic applies to so-called “clusters of antenna sites”, namely, two or more antenna sites which are geographically located sufficiently close to one another that it is presumed that a disaster affecting one antenna site of a cluster of antenna sites also affects the other antenna sites of the cluster of antenna sites. Accordingly, decisions regarding clusters of antenna sites are dependent on several factors including inter alia local terrain, density of antennas sites, and the like, and are part of a set-up of a PWSC 30. Notably decisions whether two or more antenna sites are considered as a cluster of antenna sites disregards the consideration whether the antenna sites belong to the same cellular operator or not. The decision logic can also grade the likelihood of an occurrence of a disaster from a weak indication to a strong indication based on compiled information. The greater the number of cellular networks from which information can be compiled so the reliability of PWSC 30's decision logic is higher.

The decision logic of the present invention is intended to balance between the four outcomes of True Positive (TP), True Negative (TN), False Positive (FP) and False Negative (FN) of a 2×2 confusion matrix in which “Disaster Occurrence” is a positive class and “No Disaster Occurrence” is a negative class. TP and TN are desirable outcomes in terms of the reliability of the PWSC 30's decision logic. FP and FN are undesirable outcomes in terms of the reliability of the PWSC 30's decision logic. Moreover, FP can lead to actions being taken in connection with a non-existent disaster while FN can lead to a delayed response to a disaster occurrence.

Exemplary decision logic includes:

Decision Logic 1: A single antenna site with at least one operable cell excludes a disaster area location at the antenna site. This decision logic is based on the premise that it is sufficient an antenna site has at least one operable cell irrespective of whether it has one or more inoperable cells that the antenna site is not located at a disaster area location.

Decision Logic 2: A single antenna site with an inoperable antenna array with at least two generation antennas of the same cellular operator is a relatively weak indication of a disaster area location because the inoperability may be due to the cellular operator's failure rather than a disaster.

Decision Logic 3: A single antenna site with inoperable antenna arrays belonging to at least two different cellular operators is a relatively strong indication of a disaster area location.

Decision Logic 4: Clusters of antenna sites with inoperable antenna arrays are strong indications of a disaster area location and even stronger in the case of the antenna sites belonging to different cellular operators.

Decision Logic 5: An antenna site with at least one operable cell of a cluster of antenna sites with at least one inoperable cell excludes a disaster area location at the antenna site with the at least one inoperable cell.

The PWSC 30 determines disaster area boundaries of disaster area locations. Disaster area boundaries can be simple shapes such as circles, ovals, ellipses, and the like, or polygons. The PWSC 30 displays disaster area locations, for example, disaster area locations 34A and 34B, superimposed on the geographical map 32. The PWSC 30 determines the operable cells in a disaster area location for broadcasting CB messages to user equipment.

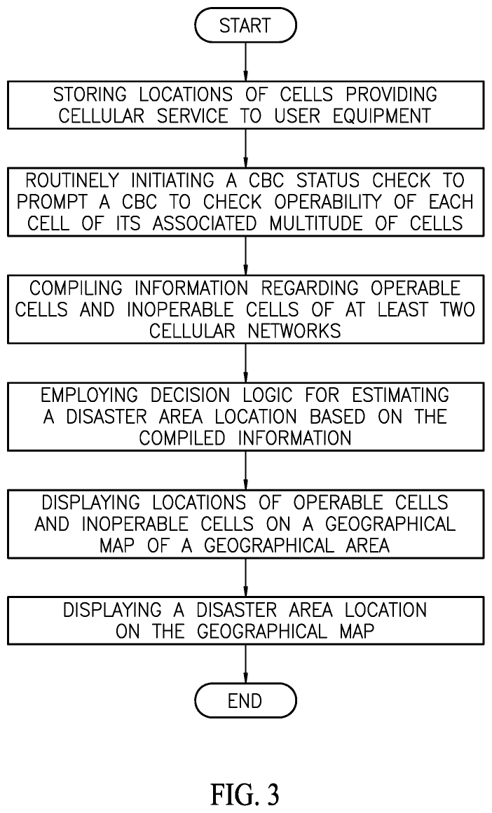

FIG. 3 shows the computer implemented PWSC 30 executes the following steps for estimating a disaster area location:

Step 1: Storing locations of cells providing cellular service to user equipment.
Step 2: Routinely initiating a CBC status check to prompt each CBC to check operability of each cell of its associated multitude of cells. Such routine checks can be, for example, twice daily, at 6 am and 6 pm.
Step 3: Compiling information regarding operable cells and inoperable cells of each cellular network.
Step 4: Employing decision logic for estimating a disaster area location based on compiled information from at least two cellular networks.

The PWSC 30 can be programmed to estimate a disaster area location also in the case of missing information from one or more cells.

The computer implemented PWSC 30 can additionally execute the following steps:

Step 5: Displaying locations of operable cells and inoperable cells on a geographical map of a geographical area.
Step 6: Displaying disaster area location(s) on the geographical map.

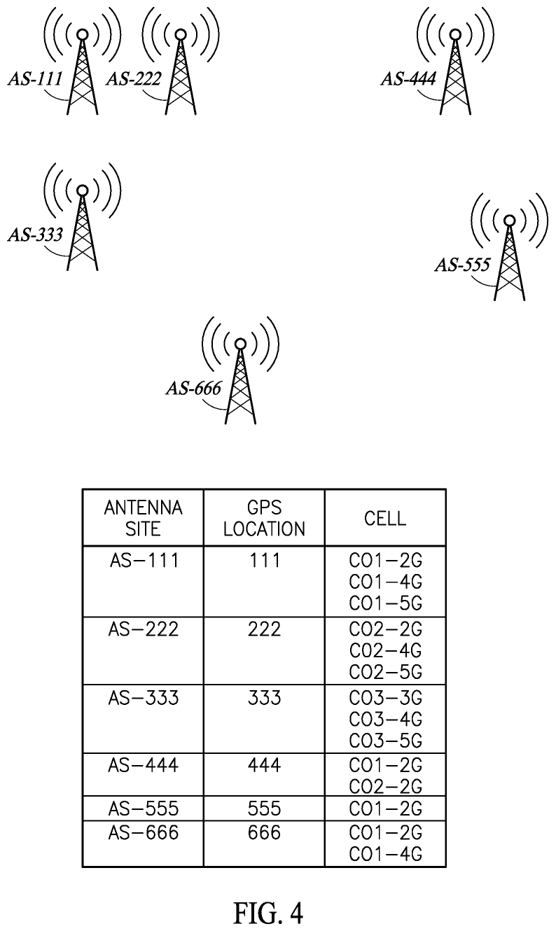

The PWSC 30's decision logic for determining disaster areas is now described with respect to several scenarios for FIG. 4's schematic layout of antenna sites AS-111, AS-222, . . . , AS-666 in which the antenna sites AS-111, AS-222 and AS-333 are considered a cluster of antenna sites as are AS-444 and AS-555.

Antenna site AS-111 at GPS location 111 has an antenna array of three antennas belonging to the cellular operator CO1 only: a 2G antenna, a 4G antenna and a 5G antenna.

Antenna site AS-222 at GPS location 222 has an antenna array of three antennas belonging to the cellular operator CO2 only: a 2G antenna, a 4G antenna and a 5G antenna.

Antenna site AS-333 at GPS location 333 has an antenna array of three antennas belonging to the cellular operator CO3 only: a 3G antenna, a 4G antenna and a 5G antenna.

Antenna site AS-444 at GPS location 444 has an antenna array of two antennas: the cellular operator CO1 has a 2G antenna and the cellular operator CO2 has a 2G antenna.

Antenna site AS-555 at GPS location 555 has an antenna array of a single 2G antenna belonging to the cellular operator CO1.

Antenna site AS-666 at GPS location 666 has an antenna array of two antennas belonging to the cellular operator CO1 only: a 2G antenna and a 4G antenna.

### Scenario 1:

Antenna sites AS-111, AS-222 and AS-333: Cellular operators CO1, CO2 and CO3 report inoperable antenna arrays, namely, all cells are inoperable.
PWSC Decision: High likelihood disaster area location at GPS locations 111, 222 and 333 as denoted by FIG. 2's disaster area location 34A.

### Scenario 2:

Antenna site AS-iii: Cellular operator CO1 report inoperable antenna array, namely, all cells are inoperable.
Antenna site AS-222: Cellular operator CO2 reports inoperable antenna array namely, all cells are inoperable.
Antenna site AS-333: Cellular operator CO3 reports operable antenna array namely, all cells are operable.
PWSC Decision: No disaster area location at GPS locations 111, 222 and 333 because cluster of antenna sites AS-111, AS-222 and AS-333 includes operable antenna array at antenna site AS-333.

### Scenario 3:

Antenna site AS-444: Cellular operator CO1 reports operable cell and cellular operator CO2 reports inoperable cell.
PWSC Decision: No disaster area location at GPS location AS-444 because antenna site AS-444 has operable cell.

### Scenario 4:

Antenna site AS-444: Cellular operator CO1 reports operable cell and cellular operator CO2 reports operable cell.
Antenna site AS-555: Cellular operator CO1 reports inoperable cell.
PWSC Decision: No disaster area location at GPS location 555 because cluster of antenna sites AS-444 and AS-555 includes operable cell at antenna site AS-444.

### Scenario 5:

Antenna site AS-666: Cellular operator CO1 reports inoperable 2G antenna and 4G antenna.
PWSC Decision: Low likelihood disaster area location at GPS location 666 as denoted by FIG. 2's disaster area location 34B due to single cellular operator reporting inoperable antennas.

While the invention has been described with respect to a limited number of embodiments, it will be appreciated that many variations, modifications, and other applications of the invention can be made within the scope of the appended claims.

1. A cellular based public warning system for use with
i) at least one Cell Broadcast Center (CBC) for broadcasting cell broadcast messages to user equipment in a multitude of cells, and
ii) at least two cellular networks providing at least partially overlapping cellular service to user equipment,
the cellular based public warning system comprising a computer implemented public warning system controller for executing the steps of:
(a) storing locations of cells providing cellular service to user equipment;
(b) routinely initiating a CBC status check to prompt a CBC to check operability of each cell of its associated multitude of cells;
(c) compiling information regarding operable cells and inoperable cells of at least two cellular networks; and
(d) employing decision logic for estimating a disaster area location based on the compiled information.

2. The method according to claim 1 and further comprising the steps of:
(e) displaying locations of operable cells and inoperable cells on a geographical map of a geographical area; and
(f) displaying a disaster area location on the geographical map.

3. The method according to claim 1 wherein the decision logic grades the likelihood of an occurrence of a disaster based on the compiled information.

4. The method according to claim 1 wherein the decision logic is programmed that an antenna site with at least one operable cell excludes a disaster area location at the antenna site.

5. The method according to claim 1 wherein the decision logic is programmed with at least one cluster of two or more antenna sites wherein each antenna site includes an antenna array with at least one antenna for providing cellular service to a cell.

6. The method according to claim 5 wherein the decision logic is programmed that an antenna site with at least one operable cell of a cluster of antenna sites excludes a disaster area location at the cluster of antenna sites.

7. A computer implemented public warning system controller for use with:
i) at least one Cell Broadcast Center (CBC) for broadcasting cell broadcast messages to user equipment in a multitude of cells, and
ii) at least two cellular networks providing at least partially overlapping cellular service to user equipment,
the computer implemented public warning system controller for executing the steps of:
(a) storing locations of cells providing cellular service to user equipment;
(b) routinely initiating a CBC status check to prompt a CBC to check operability of each cell of its associated multitude of cells;
(c) compiling information regarding operable cells and inoperable cells of at least two cellular networks; and
(d) employing decision logic for estimating a disaster area location based on the compiled information.

8. The controller according to claim 7 further executing the steps of:
(e) displaying locations of operable cells and inoperable cells on a geographical map of a geographical area; and
(f) displaying a disaster area location on the geographical map.

9. The controller according to claim 7 wherein the decision logic grades the likelihood of an occurrence of a disaster based on the compiled information.

10. The controller according to claim 7 wherein the decision logic is programmed that an antenna site with at least one operable cell excludes a disaster area location at the antenna site.

11. The controller according to claim 7 wherein the decision logic is programmed with at least one cluster of two or more antenna sites wherein each antenna site includes an antenna array with at least one antenna for providing cellular service to a cell.

12. The controller according to claim 11 wherein the decision logic is programmed that an antenna site with at least one operable cell of a cluster of antenna sites excludes a disaster area location at the cluster of antenna sites.

13. A method of operation of a cellular based public warning system for use with:
i) at least one Cell Broadcast Center (CBC) for broadcasting cell broadcast messages to user equipment in a multitude of cells, and
ii) at least two cellular networks providing at least partially overlapping cellular service to user equipment,
the method of operation comprising the steps of:
(a) storing locations of cells providing cellular service to user equipment;
(b) routinely initiating a CBC status check to prompt a CBC to check operability of each cell of its associated multitude of cells;
(c) compiling information regarding operable cells and inoperable cells of at least two cellular networks; and
(d) employing decision logic for estimating a disaster area location based on the compiled information.

14. The method according to claim 13 and further comprising the steps of:
(e) displaying locations of operable cells and inoperable cells on a geographical map of a geographical area; and
(f) displaying a disaster area location on the geographical map.

15. The method according to claim 13 wherein the decision logic grades the likelihood of an occurrence of a disaster based on the compiled information.

16. The method according to claim 13 wherein the decision logic is programmed that an antenna site with at least one operable cell excludes a disaster area location at the antenna site.

17. The method according to claim 13 wherein the decision logic is programmed with at least one cluster of two or more antenna sites wherein each antenna site includes an antenna array with at least one antenna for providing cellular service to a cell.

18. The method according to claim 17 wherein the decision logic is programmed that an antenna site with at least one operable cell of a cluster of antenna sites excludes a disaster area location at the cluster of antenna sites.
